(19) United States
(12) Patent Application Publication
(10) Pub. No.: US 2018/0246667 A1
(43) Pub. Date: Aug. 30, 2018

(54) FILE SYSTEM AND PROGRAM

(71) Applicant: HITACHI SOLUTIONS, LTD., Tokyo (JP)

(72) Inventors: Hiroyuki OTA, Tokyo (JP); Yuuichi KIYOKAWA, Tokyo (JP); Hiroshi KURATA, Tokyo (JP); Naoyuki YOKOI, Tokyo (JP)

(21) Appl. No.: 15/755,099

(22) PCT Filed: Oct. 11, 2016
(86) PCT No.: PCT/JP2016/080080

§ 371 Date: Feb. 26, 2018

(30) Foreign Application Priority Data
Nov. 13, 2015 (JP) 2015-223083

(51) Int. Cl. G06F 3/06; G06F 17/30

(52) U.S. Cl. CPC G06F 3/0643; G06F 17/30138; G06F 17/30153

(57) ABSTRACT

A file system includes a calculator and a module. The calculator includes a storage unit and an auxiliary storage device. The storage unit temporarily stores data. The auxiliary storage device includes a disk that permanently stores the data. The module is configured to execute a compression process on I/O-requested data using a compression algorithm. The module is configured to separate and store the compressed data in the storage unit and the auxiliary storage device.

### TECHNICAL FIELD

The present invention relates to a file system and a program.

### BACKGROUND ART

Examples of means for security of data in a terminal such as a Personal Computer (PC) handling confidential information files include encryption of an auxiliary storage device, automatic periodic data deletion, and usage of a memory. For example, a mechanism like Patent Literature 1 is employed for the encryption of the auxiliary storage device.

### CITATION LIST

### Patent Literature

Patent Literature 1: JP 2014-48635 A

### SUMMARY OF INVENTION

### Technical Problem

However, the encryption of the auxiliary storage device involves a risk of decryption. Additionally, the automatic periodic data deletion is merely a logical deletion and therefore a risk of physical restoration, such as an analysis from an auxiliary storage device sector, is present.

Although the usage of the memory is excellent in terms of security of data, there is a drawback of considerably small available disk capacity from an aspect of a small capacity and an effect of the memory.

Therefore, the present invention provides a technique that can store large-capacity data while maintaining volatility of a memory.

### Solution to Problem

For example, to solve the problems, the configurations described in claims are employed. This application includes a plurality of means to solve the problems. One example is a file system that includes a calculator and a module. The calculator includes a storage unit and an auxiliary storage device. The storage unit temporarily stores data. The auxiliary storage device includes a disk that permanently stores the data. The module is configured to execute a compression process on I/O-requested data using a compression algorithm. The module is configured to separate and store the compressed data in the storage unit and the auxiliary storage device.

### Advantageous Effects of Invention

The present invention can store large-capacity data while maintaining volatility of a memory. Further features related to the present invention are clarified from the description of the present specification and the accompanying drawings. Problems, configurations, and effects other than ones described above will be clarified in the following explanation of embodiments.

### BRIEF DESCRIPTION OF DRAWINGS

FIG. 1 is a block diagram of a file system according to an embodiment of the present invention.

FIG. 2 is a flowchart of when a file I/O request packet is registered with a file system filter driver.

FIG. 3 is a flowchart of when a compression process separates and stores data in a memory and an auxiliary storage device in a file system according to the embodiment of the present invention.

FIG. 4 is a flowchart of when the separated data is restored to referenceable data in the file system according to the embodiment of the present invention.

### DESCRIPTION OF EMBODIMENTS

The following describes embodiments of the present invention with reference to the attached drawings. Although the accompanying drawings illustrate specific embodiments based on the principle of the present invention, these are used to understand the present invention and are never used to interpret the present invention in a limited manner.

The following embodiments relate to a file system combining a memory and an auxiliary storage device. More specifically, the following embodiments relate to a volatile virtual disk system independent of a memory capacity. This virtual disk system stores data using the memory and the auxiliary storage device in combination in a terminal handling confidential information files such as a PC, thus having advantages of both volatility of the memory and a large-capacity data area of the auxiliary storage device.

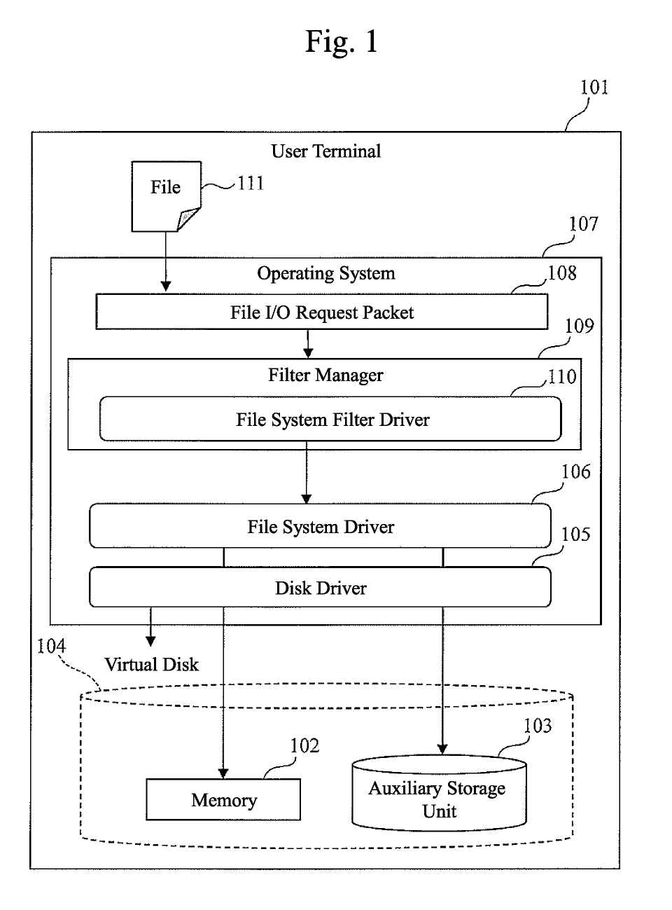

FIG. 1 is a block diagram of the file system according to the embodiment of the present invention. In FIG. 1, a user terminal 101 is constituted of a calculator such as a personal computer. The calculator includes a CPU (or, also referred to as a processor), a memory 102, which temporarily stores data, and an auxiliary storage device 103, which includes a disk permanently storing data. As one example, the auxiliary storage device 103 is a non-volatile hard disk drive. FIG. 1 omits the illustration of the CPU in the user terminal 101.

An operating system (OS) 107 is installed on the user terminal 101. A file system driver 106, a disk driver 105, and a filter manager 109 are installed on the user terminal 101. For example, the file system driver 106, the disk driver 105, and the filter manager 109 are functions provided by the operating system 107. Obviously, any way of provision of these processing modules is applicable as long as processes described in the following are possible.

The filter manager 109 filters a file I/O request packet 108 created when a file 111 is stored. A file system filter driver 110 to execute the processes described in the following is installed on the user terminal 101. For example, the file system filter driver 110 is provided in a form of being incorporated into the filter manager 109. The user terminal 101 includes a virtual disk 104 virtually expressed as a single disk by the file system filter driver 110. As illustrated in FIG. 1, the virtual disk 104 is constituted of the memory 102 and the auxiliary storage device 103.

When a user stores the file 111 on the user terminal 101 or when referring to the file 111 on the user terminal 101, the user executes the operation on the virtual disk 104. The operating system 107 creates packets including I/O content and passes I/O request packets to the file system filter driver 110 through the filter manager 109.

The file system filter driver 110 analyzes the packet content. When the analysis finds out that the packet content is the operation to the virtual disk 104, the file system filter driver 110 executes a compression/decompression process of the file 111 and executes file access to the virtual disk 104 (namely, the memory 102 and the auxiliary storage device 103) via the file system driver 106 and the disk driver 105.

During the compression process, the file system filter driver 110 divides and stores the data in the memory 102 and the auxiliary storage device 103. Meanwhile, during the decompression process, the file system filter driver 110 combines and decompresses the data in the memory 102 and the auxiliary storage device 103. This allows the user to use the large-capacity volatile disk without conscious of the memory 102 and the auxiliary storage device 103.

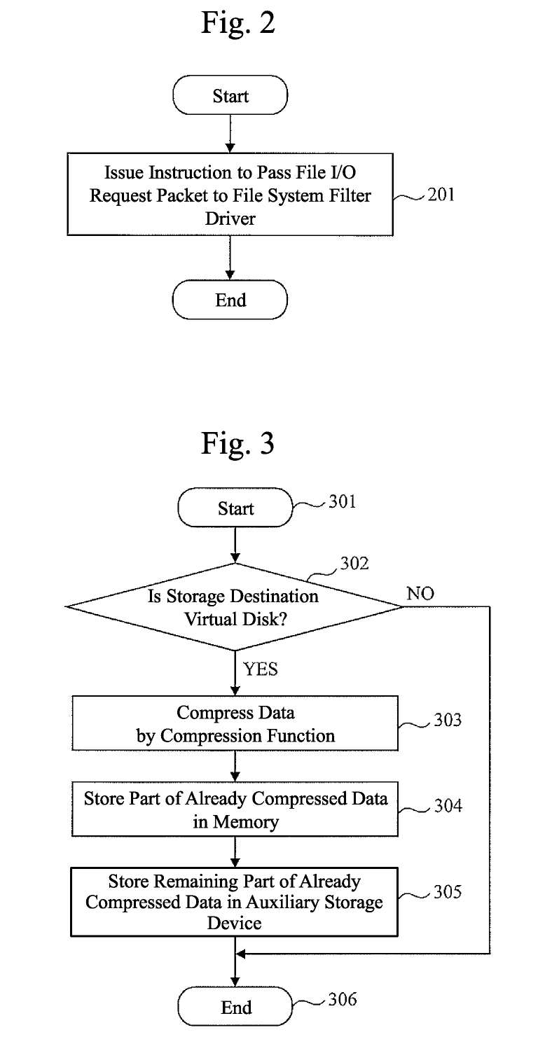

FIG. 2 is a flowchart of when the file I/O request packets are registered with the file system filter driver 110.

As described above, the filter manager 109 is the function provided in the operating system 107. By the filter manager 109 issuing an instruction to the operating system 107, the file I/O request packet 108 managed by the operating system 107 can be passed to the file system filter driver 110 through the filter manager 109. In view of this, when the file I/O request packet 108 is created, the filter manager 109 processes an instruction (Step 201) to receive the file I/O request packet 108 by the file system filter driver 110.

The following describes processes of when the file system filter driver 110 receives the file I/O request packet 108. FIG. 3 is a flowchart of when the compression process separates and stores the data in the memory 102 and the auxiliary storage device 103.

The file system filter driver 110 receives the file I/O request packet 108 through the filter manager 109 (Step 301).

The file system filter driver 110 determines whether the received file I/O request packet 108 is a packet requesting writing to the virtual disk 104 (Step 302). As one example of the determination method, the file system filter driver 110 confirms a file path stored in the packet, and when a specific mount point is specified, the file system filter driver 110 may determine that the writing to the virtual disk 104 is requested. For example, “mnt/ramdisk” and “R: [symbol] ” are used as the path to access the virtual disk 104, and when the path is the corresponding file path, it is regarded as the file access to the virtual disk 104.

When the packet received at Step 301 is not the process to the virtual disk 104, the file system filter driver 110 passes the packet to the file system driver 106 as it is and terminates the process (Step 306).

When the packet received at Step 301 is the process to the virtual disk 104, the file system filter driver 110 executes the compression process on the packet using a compression algorithm (Step 303). Various process methods such as a dictionary compression, a block sort, and an encoding compression are available as the compression process. This mechanism is an application of a property in which data cannot be restored if information entropy falls below the limit and does not limit the compression process method. However, in order to make the surmise of missing information difficult, the use of a dynamic encoding method using Range Coder, an arithmetic encoding, or the like is preferable.

The file system filter driver 110 stores a part of the data compressed at Step 303 in the memory 102 via the file system driver 106 and the disk driver 105 (Step 304).

Next, the file system filter driver 110 stores the remaining part of the data compressed at Step 303 in the auxiliary storage device 103 via the file system driver 106 and the disk driver 105 (Step 305).

The compressed data cannot be restored if a part of the data is missing. In view of this, a ratio of distribution of data divided in the memory 102 and the auxiliary storage device 103 and the division method are variable according to the memory capacity mounted to the system and a degree of difficulty of data restoration required for the system. As one example, utilizing the large-capacity auxiliary storage device 103, the data amount stored in the auxiliary storage device 103 may be larger than the data amount stored in the memory 102. As another example, the file system filter driver 110 may dynamically create an initial frequency table required for the restoration of data using the arithmetic encoding method and store only this frequency table in the memory 102. As another example, the file system filter driver 110 may store a part of data in the memory 102 in addition to the initial frequency table. This ensures further improvement in the degree of difficulty of restoration.

Any method is employed as the method of associating the data divided and stored in the memory 102 and the auxiliary storage device 103. As one example, the file system filter driver 110 may add storage destination information on the auxiliary storage device 103 to the data stored in the memory 102. As another example, a method that assigns fixed different drive letters in the memory 102 and the auxiliary storage device 103 and completely matches the file paths other than the drive letters is considered.

When the data storage is completed, the file system filter driver 110 terminates the process (Step 306).

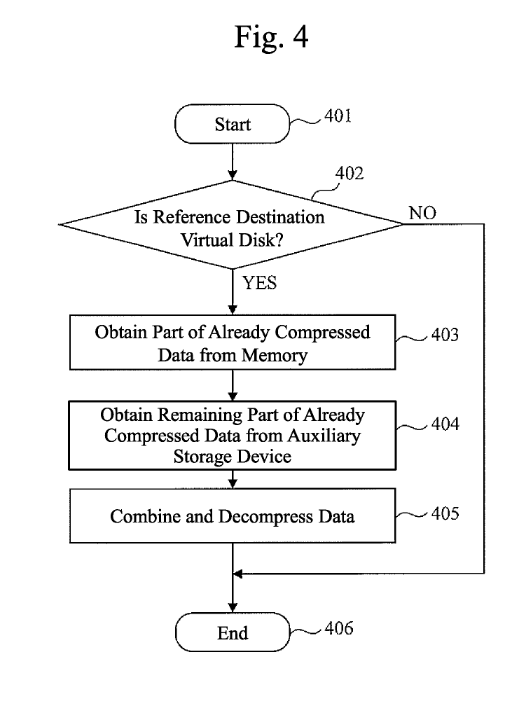

FIG. 4 is a flowchart when the separated data is restored to referenceable data.

The file system filter driver 110 receives the file I/O request packet 108 through the filter manager 109 (Step 401).

The file system filter driver 110 determines whether the received file I/O request packet 108 is a packet requesting reading of data in the virtual disk 104 (Step 402).

When the packet received at Step 401 is not the process to the virtual disk 104, the file system filter driver 110 passes the packet to the file system driver 106 as it is and terminates the process (Step 406).

When the packet received at Step 401 is the process to the virtual disk 104, the file system filter driver 110 obtains a part of the already compressed data from the memory 102 (Step 403). The file system filter driver 110 obtains the remaining part of already compressed data from the auxiliary storage device 103 (Step 404).

Next, the file system filter driver 110 combines the data obtained from the memory 102 and the auxiliary storage device 103 and executes the decompression process using the compression algorithm employed in the system (Step 405). When the data decompression process is completed, the file system filter driver 110 terminates the process (Step 406).

According to the above-described embodiment, there is provided the virtual disk system constituted of the calculator including the memory 102, which temporarily stores the file, and the auxiliary storage device 103, which permanently stores the file. This virtual disk system has the function to compress the I/O-requested file using the compression algorithm and the function to memorize the compressed file in the memory 102 and the auxiliary storage device 103 (for example, the former part in the memory 102 and the latter part in the auxiliary storage device 103). This virtual disk system includes the file system filter driver 110, which utilizes the areas in the memory 102 and the auxiliary storage device 103 and handles the memory 102 and the auxiliary storage device 103 as if the memory 102 and the auxiliary storage device 103 were one drive, and has the compression function.

When writing the file, the file system filter driver 110 compresses the input file by the known compression method and stores the output result in the memory 102 and in auxiliary storage device 103. When reading the file, the file system filter driver 110 first obtains the data in the memory 102 and then obtains the data in the auxiliary storage device 103, combines both, and then restores the data.

The virtual disk system according to this embodiment doubles as the volatility of the memory 102 and the large capacity of the auxiliary storage device 103, thereby ensuring storing the large-capacity data while utilizing the volatility of the memory 102. The application of volatility in which the data is deleted when the power to the system is shut off due to a shutdown becomes possible, thus ensuring the data security.

This method is applicable to various storage devices, not only the memory 102 and the auxiliary storage device 103. For example, the use of a USB flash drive as the substitution for the memory 102 ensures achieving an encrypted file system with the USB flash drive as the key. In this case, for example, it may also be configured such that the USB flash drive temporarily stores the key for the data and the entire data cannot be restored without the USB flash drive. This configuration allows using the auxiliary storage device that can store the large-capacity data while making the data security possible. The use of the auxiliary storage device 103 as the substation for the memory 102 and the use of an online storage as the substation for the auxiliary storage device 103 allows safety use of an inexpensive cloud storage.

The present invention is not limited to the above-described embodiments and includes various modifications. The embodiments are described in detail for easy understanding of the description of the present invention, and do not necessarily include all the described configurations. A part of the configuration of one embodiment can be replaced by the configuration of another embodiment. The configuration of one embodiment can be used with the addition of the configuration of another embodiment. For a part of the configurations in the respective embodiments, another configuration can be added, deleted, or replaced.

For example, the above-described respective configurations and functions may be achieved by software with which the processor interprets and executes the programs achieving the respective functions. A various kinds of non-transitory computer readable medium can memorize information such as the programs achieving the respective functions and the files. For example, as the non-transitory computer readable medium, a storage device such as a memory, a hard disk, and a Solid State Drive (SSD), or a recording medium such as an IC card, an SD card, and a DVD are applicable. The above-described respective configurations or the like may be achieved by hardware, for example, a part of or all of which are designed with, for example, an integrated circuit.

In the above-described embodiments, control lines and information lines considered necessary for the description are described. Not all the control lines and the information lines on the product are necessarily described. All configurations may be mutually coupled.

### REFERENCE SIGNS LIST

101 User terminal
102 Memory
103 Auxiliary storage unit
104 Virtual disk
105 Disk driver
106 File system driver
107 Operating system
108 File I/O request packet
109 Filter manager
110 File system filter driver
111 File

1. A file system comprising:
a calculator that includes a storage unit and an auxiliary storage device, the storage unit temporarily storing data, the auxiliary storage device including a disk permanently storing data; and
a module configured to execute a compression process on I/O-requested data using a compression algorithm, the module being configured to separate and store the compressed data in the storage unit and the auxiliary storage device.

2. The file system according to claim 1,
wherein the module is configured to combine the data separated and stored in the storage unit and the auxiliary storage device, the module being configured to decompress the combined data using the compression algorithm.

3. The file system according to claim 1,
wherein the storage unit and the auxiliary storage device are configured as a single virtual disk.

4. The file system according to claim 1,
wherein the compression algorithm is a dynamic encoding method.

5. A non-transitory computer readable medium that stores a program to store I/O-requested data in a calculator, the calculator including a processor, a storage unit, and an auxiliary storage device, the storage unit temporarily storing data, the auxiliary storage device including a disk permanently storing the data,
wherein the program causes the processor to execute:
a process of executing a compression process on the I/O-requested data using a compression algorithm; and
a process of separating and storing the compressed data in the storage unit and the auxiliary storage device.
